(19) United States
(12) Patent Application Publication
(10) Pub. No.: US 2002/0138213 A1
(43) Pub. Date: Sep. 26, 2002

(54) System and method of metabolic rate measurement

(76) Inventor: James R. Mault, Evergreen, CO (US)

Correspondence Address: GIFFORD, KRASS, GROH, SPRINKLE,, ANDERSON & CITKOWSKI, P.C., STE. 400, 280 N. OLD WOODWARD AVE., BIRMINGHAM, MI, 48009, US

(21) Appl. No.: 10/090,984

(22) Filed: Mar. 4, 2002

Related U.S. Application Data
(60) Provisional application No. 60/273,143, filed on Mar. 2, 2001.
(60) Provisional application No. 60/275,931, filed on Mar. 15, 2001.

(51) Int. Cl. G06F 19/00; G01N 31/00

(52) U.S. Cl. 702/32

(57) ABSTRACT

A spirometer for determining a metabolic rate for an individual includes a flow pathway and a flow sensor disposed in the flow path, such that the flow sensor senses a flow rate of exhaled gas from the individual through the flow path. The spirometer also includes a processor having a memory in communication with the flow sensor. A method of metabolic rate measurement for the individual includes the steps of measuring an exhaled gas volume for the individual using the spirometer, determining a respired gas volume for the individual using the exhaled gas volume and a ventilatory equivalent, and determining a metabolic rate for the individual from the respired volume.

### RELATED APPLICATIONS

This application claims priority of U.S. Provisional Patent Application No. 60/273,143 filed Mar. 2, 2001 and No. 60/275,931 filed Mar. 15, 2001, which are incorporated herein by reference.

### FIELD OF THE INVENTION

The invention relates to indirect calorimetry, and more specifically to the use of indirect calorimetry to determine the metabolic rate for an individual.

### BACKGROUND OF THE INVENTION

The measurement of a person's metabolic rate can provide extremely useful information for fitness planning, weight loss programs, cardiac recovery programs, and other health-related programs. For example, in a weight control program, the resting metabolic rate is important in calculating the calorie expenditure of the person. Metabolic rate determination during exercise allows calculation of energy expended during the exercise.

The indirect calorimeter is used to determine the metabolic rate of an individual by measuring their oxygen consumption during respiration over a period of time. A variety of indirect calorimeters for measuring oxygen consumption during respiration have been devised. One form of a respiratory calorimeter is disclosed in U.S. Pat. Nos. 4,019,108; 5,038,792; and 5178,155 all to Mault, which are incorporated herein by reference. In this type of calorimeter, the volume of a subject's inhalations are measured over a period of time, and the volume of the subject's exhalations after carbon dioxide in the exhalations have been removed by an absorbent scrubber are also measured. These measurements are integrated over the time of measurement and the difference between the two summed volumes is a measure of the individual's oxygen consumption. This follows from the fact that inhaled oxygen is either absorbed into the blood in the subject's lungs or expelled during exhalation. Some portion of the blood absorbed oxygen is replaced with CO₂. When the CO₂ is removed from the exhaled volume, the summed difference between inhalation and exhalation volume over a period of time is equal to the absorbed oxygen. In some versions of the prior calorimeters, a capnometer was also used to measure the instantaneous value of the exhaled CO₂ in a breath allowing the calculation of CO₂ production, Resting Energy Expenditure (REE) and Respiratory Quotient (RQ).

More recently, an improved indirect calorimeter known as a gas exchange monitor (GEM) is disclosed in U.S. Pat. No. 6,309,360 BI also to Mault, which is incorporated herein by reference. Other indirect calorimeter embodiments are described in U.S. Pat. Nos. 6,135,107 and 5,836,300. The GEM provides for accurate determination of a subject's metabolic rate, both at rest and during exercise. The GEM includes a pair of ultrasonic transducers so as to determine gas flow rates through the device, and a fluorescence oxygen sensor so as to determine the effectively instantaneous O₂ concentration within the gas flow. By integrating flow rate data and oxygen concentration data into flow volumes of O₂, and subtracting exhaled O₂ volumes from inhaled O₂ volumes, the consumed volume of O₂, and hence the metabolic rate of a subject is determinable.

Another respiratory parameter related to metabolic rate is the respiratory quotient (RQ). The RQ is defined as the ratio of the volume of CO₂ produced to the volume of O₂ consumed, i.e. RQ=VCO₂/VO₂. This typically varies within the range 0.7 to 1, depending on the metabolic processes of the person. If RQ is greater than 1, then the individual is consuming more calories than they are expending. This will result in fat storage. In carbohydrate metabolism, one mole of carbon dioxide is produced for each mole of oxygen consumed, hence RQ=1. In order to metabolize fat, RQ should be about 0.7, whereas for protein metabolism RQ˜0.8. For a person at rest, RQ is typically around 0.82-0.85. Lower values of RQ may indicate fat consumption by the body. RQ can be measured directly if oxygen consumption volume and carbon dioxide production volume measurements are made, as described in the '360 patent. Gas volumes are converted to volumes at standard conditions, conventional body temperature and standard pressure (BTSP) or standard temperature and pressure, dry (STPD). Exhaled gases may be assumed to be at body temperature and at 100% humidity.

While the GEM and other types of indirect calorimeters work well in measuring the oxygen consumption of an individual, there is a need in the art for a method of determining the metabolic rate of an individual using a cost-efficient device.

### SUMMARY OF THE INVENTION

Accordingly, the present invention is a system and method of metabolic measurement for an individual. The system includes a flow path and a flow sensor disposed in the flow path, such that the flow sensor senses a flow rate of exhaled gas from the individual through the flow path. The spirometer also includes a processor having a memory in communication with the flow sensor.

The method of metabolic rate measurement for the individual includes the steps of measuring an exhaled gas volume for the individual using the spirometer , determining a respired gas volume for the individual using the exhaled gas volume and a ventilatory equivalent; and determining a metabolic rate for the individual from the respired volume.

One advantage of the present invention is that a system and method of metabolic measurement for an individual is provided that uses a cost-efficient device. Another advantage of the present invention is that a spirometer is used to measure the volume of gas inhaled or exhaled by an individual, and used to determine metabolic rate. Still another advantage of the present invention is that the method of determining the metabolic rate of an individual uses exhaled gas volume and a numerical parameter related to the ventilatory equivalent for the individual. A further advantage of the present invention is that ventilatory equivalent is estimated from a physiological parameter. Still a further advantage of the present invention is that a micro-machined ultrasonic transducer is used to measure parameters such as temperature, humidity and pressure.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a schematic diagram of a system for metabolic rate measurement for an individual, according to the present invention.

FIG. 2 is a graph illustrating the breath flow rate over time using the system of FIG. 1, according to the present invention.

FIG. 3 is a graph illustrating the VEQ for an individual using the system of FIG. 1, according to the present invention.

FIG. 4 is a graph illustrating VCO₂ for an individual using the system of FIG. 1, according to the present invention.

FIG. 5 is a schematic diagram of an alternative embodiment of a system for measuring the metabolic rate of an individual, according to the present invention.

FIG. 6 is a flowchart of a method of measuring metabolic rate using the system of FIG. 1 or FIG. 5, according to the present invention.

### DETAILED DESCRIPTION OF THE PREFERRED EMBODIMENT

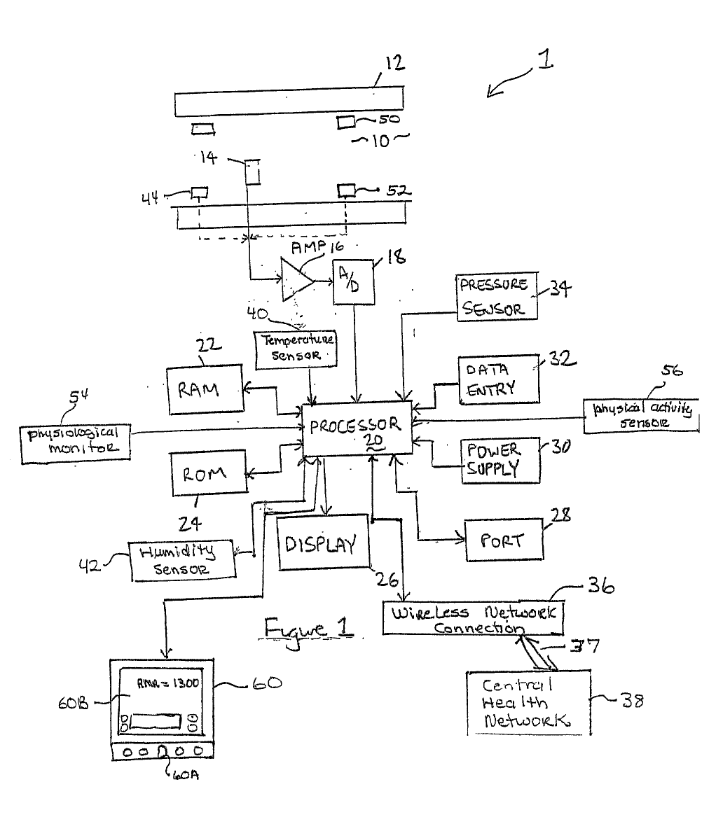

Referring to FIG. 1, a spirometer for use in metabolic rate measurement for an individual is illustrated. The spirometer measures a volume of gas inhaled or exhaled by the individual over a predetermined period, such as per breath, per minute, or some other time interval. The measured volume of gas inhaled or exhaled is used to calculate metabolic rate using known relationships. The exhaled volume per minute is denoted V_{E}. Oxygen consumption volume per minute is denoted VO₂, and carbon dioxide volume production per minute is denoted VCO₂. Volumes are corrected to standard conditions.

There are two known ventilatory equivalents which relate V_{E} to VO₂ and VCO₂:

VEQ(O₂)=V_{E}/O₂

VEQ(CO₂)=V_{E}/VCO₂

It should be appreciated that ventilatory equivalent (VEQ) is assumed to be the ventilatory equivalent for oxygen VEQ(O₂) unless otherwise stated. Advantageously, the VEQ for an individual can be measured using an indirect calorimeter, such as the GET as previously described. The GEM determines an oxygen consumption volume for a subject, from which a metabolic rate is determined. The exhaled oxygen volume is determined by measuring the exhaled flow rate and instantaneous oxygen concentration of exhaled breath. Integration of flow rate and oxygen concentration signals provides an exhaled oxygen volume measurement, which is subtracted from an inhaled oxygen volume measurement to determine an oxygen consumption volume. Integration of flow rate signals alone for exhaled breaths provides an exhaled volume measurement, and hence the ventilatory equivalent can be determined from the ratio of exhaled volume to the oxygen consumption volume. The processor of an indirect calorimeter can be used to determine the VEQ, and VEQ data can be shown on a display, along with metabolic rate data.

The GEM can also be readily adapted to measure VEQ, by integrating exhaled flow rates to determine exhaled volume, and dividing this by the volume of oxygen consumed over the same time scale (for example, one minute or some number of breaths). The determined ventilatory equivalent VEQ can be entered into a suitably adapted spirometer, and used to estimate oxygen consumption and hence metabolic rate from measured exhaled volumes.

The GEM can also be used to measure the resting metabolic rate (RMR) of an individual for a predetermined period of time. For example, metabolic rate can be determined from oxygen volume consumed and carbon dioxide volume produced using the Weir equation, as discussed in the '360 patent. For a person at rest, the resting metabolic rate RMR in kcal/day is given by:

RMR=1.44 (3.581VO₂+1.448VCO₂)−17.73

The constant term 17.73 is related to nitrogen metabolism, and is not necessary. The volumes are those under standard conditions (STPD, standard temperature and pressure, dry, i.e. 0% humidity, 0° C., 760 mmHg). The Weir equation can be rewritten so as to depend only on VO₂ or VCO₂ using a respiratory quotient (RQ), where RQ=VCO₂VO₂. For example, if RQ=0.85, the equation can be written as:

RMR=6.93 VO₂

or

RMR=8.15 VCO₂

Hence, if exhaled volume V_{E} is measured, RMR is calculated by determining VO₂ or VCO₂ using an appropriate ventilatory equivalent, and volume is corrected to standard conditions, as is known in the art. If both VO₂ and VCO₂ are determined, then RMR can be calculated using the Weir equation. However, if only one ventilatory equivalent is known, so that either VO₂ or VCO₂ is determined from V_{E}, then a value of respiratory quotient is needed to calculate RMR. The RQ, as previously described is measured for a person under controlled conditions (for example at rest after fasting), so that the measured value of RQ is appropriate if an RMR is later determined under similar conditions. Alternatively, RQ can also be estimated using demographic information, diet, and the like. RQ is preferably measured or estimated for conditions suitable for RMR determination, such as for a person at rest, several hours after a meal.

Hence, RMR can be determined using a flow meter and an equation of the form:

RMR=A V_{E}/VEQ(O₂)

where the parameter A includes calculated temperature, pressure, and humidity correction factors, and VEQ is determined in a calibration process, in which VEQ is found so that the RMR given using this equation agrees with the RMR determined using another means. For example, by preferably using an indirect calorimeter, such as the GEM. It should be appreciated that an equation for predicting RMR, known in the art as the Harris-Benedict equation, may also be used, though this is not a preferred method. For optimum accuracy, the ambient pressure is determined and used in correcting exhaled volumes to standard conditions (or, equivalently, used in correcting the value of parameter A). However, for a low cost device, the atmospheric pressure is assumed to be 1 atm.

An equation of the form RMR=B V_{E} can also be established, where the parameter B includes a number of experimentally determinable or estimable parameters, such as the effective temperature of exhaled breath, ambient pressure, RQ, and VEQ. For example, a person may exhale a certain volume of air in one minute. From this volume, an oxygen consumption volume is determined if VEQ is known. After correcting volumes to standard conditions, the metabolic rate is calculated using the Weir equation, providing a value of respiratory quotient is known or assumed. The value of B is determined for an individual by comparing the exhaled volume of the individual with the metabolic rate of the individual, and the metabolic rate is determined using an indirect calorimeter or an expression in terms of demographic data such as age, weight, gender, height, ethnicity, body fat percentage, and the like. The value of B is estimated by estimating the ventilatory equivalent for the person.

The spirometer 1 measures the flow of gas and includes a flow path 10 enclosed by a flow tube 12 (represented in cross section). The spirometer 1 also includes a flow sensor 14. The flow sensor 14 is disposed in the flow path 10 of the flow tube 12 and senses the flow of gas through the flow tube 12.

One example of a flow sensor 14 is a pressure differential transducer that provides a signal correlating with the pressure difference across a flow obstruction (or pneumotach). This type of flow sensor 14 is described in U.S. Pat. No. 5,562,101 to Hankinson or in U.S. Pat. No. 5,038,773 to Norlien. Another example of a flow sensor 14 is a hot wire flow sensor 14 or hot wire anemometer, such as the flow sensor 14 described in U.S. Pat. No. 5,518,002 to Wolf, or other heated element flow sensor 14. Still another example of a flow sensor 14 is an ultrasonic Doppler frequency shift sensor. A further example of a flow sensor 14 is a turbine or impeller based sensor, such as the sensor described in U.S. Pat. No. 4,658,832 to Brugnoli. Still a further example of a flow sensor 14 is a micro-machined structure which undergoes flow induced distortions which are detected, e.g. electrically. Yet a further example of a flow sensor 14 is a vortex shedding detector. It should be appreciated that the pressure of exhaled air is assumed to be the atmospheric pressure, and determined volumes are corrected to standard conditions, as required by the Weir equation, so that pressure is preferably measured.

The flow sensor 14 provides a data signal with the gas flow volume information to an amplifier 16 and an analog-to-digital converter 18. The digital signal from the converter 18 is transmitted to a processor 20. The processor 20 includes a memory, such as RAM 22 and/or ROM 24. The spirometer 1 also includes a display 26, a data communications port 28, and a pressure sensor 34. The spirometer 1 receives power from a power supply 30, such as a battery.

The spirometer 1 also includes a wireless network connection 36 for operatively communicating over a communications network 37 to a central health network 38 to transfer or receive data. It should be appreciated that the central health network 38 may be a doctor's office, hospital or other such health care provider. The spirometer 1 further includes a data entry mechanism 32, such as a keypad, buttons, stylus entry, touch screen, or other mechanism, so that a user of the spirometer 1 can enter VEQ data into the spirometer 1.

The spirometer 1 further includes a temperature sensor 40 for measuring the temperature of the gases. Preferably the temperature sensor 40 responds faster than the flow sensor 14. However, during an exhalation, it is reasonable to assume that the gas is at, or slightly below, body temperature. The spirometer 1 still further includes a humidity sensor 42. However, again during an exhalation it is reasonable to assume that exhaled gases are at 100% humidity.

In another example, the spirometer 1 includes a pair of ultrasonic transducers 44 disposed within the flow path, so as to transmit and receive ultrasonic pulses along the flow path. The use of micro-machined ultrasonic transducers reduces the cost of such devices. An example of such a sensor is made by Sensant Technologies of San Leandro, Calif. Temperature, humidity, and pressure sensors are preferably integrated into a micro-machined transducer, which can lower production costs. These transducers are also useful in determining oxygen consumption using ultrasonic measurements alone (i.e., not using a separate gas component concentration sensor). This technique is described in PCT Application No. WO 00/07498 to Mault.

The transit time of pulses is related to the flow rate within the flow path 10. An example of determining flow rate using an ultrasonic transducer is disclosed in U.S. Pat. Nos. 5,647,370; 5,645,071; 5,503,151 and 5,419,326 to Hainoncourt, U.S. Pat. No. 5,562,101 to Hankinson et al.; U.S. Pat. Nos. 5,831,175 and 5,777,238 to Fletcher-Haynes; and U.S. Pat. No. 6,189,389 to van Bekkum et al., the contents of all of which are incorporated herein by reference. It should be appreciated that digital signals may be provided to the processor 20 according to the transit times of pulse propagation between two transducers, such as using the technique described in commonly invented U.S. Pat. No. 6,309,360 B1, previously described. Temperature correction and compensation methods are well known in the art for these types of transducers.

The processor 20 detects the beginning and end of breaths using periods of flow zeros and flow reversals, and integrates flow rate data to determine flow volumes for exhaled and inhaled breaths. Total exhaled volume per minute (V_{E}) is calculated by accumulating exhaled volumes measured over a period of time, and divided by the time of measurement. A discrete number of breaths, such as ten, can be used to determine V_{E}.

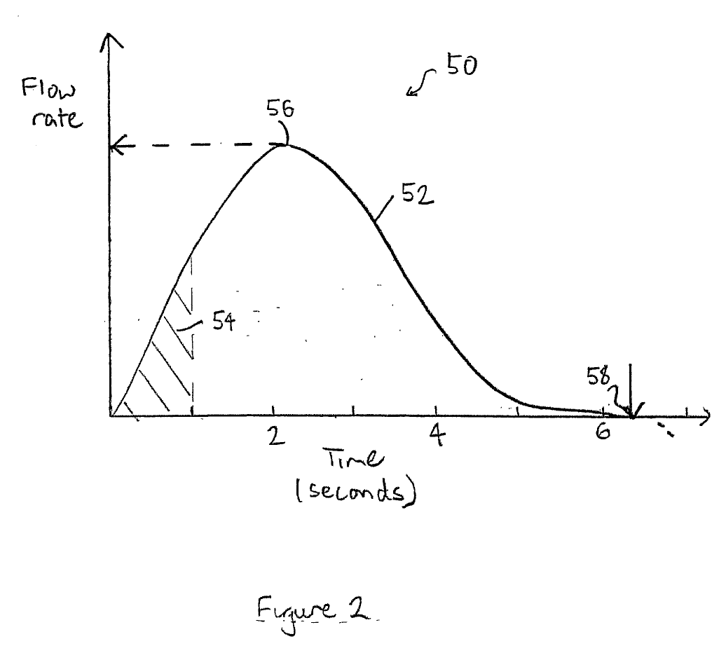

Referring to FIG. 2, a graph 50 illustrating a breath flow profile using the spirometer 1 of FIG. 1 is illustrated. It is assumed that the breath flow is exhalation. The area under the flow curve 52 is related to the tidal volume. It should be appreciated that flow parameters useful in determining respiratory function may also be determined, such as peak flow as shown at 56, FEV1 as shown at 54 which is the shaded area defined by the curve at the 1 second boundary, exhalation length, which corresponds to the time at the end of the breath as shown at 58, and other parameters known in the art. The curves for normal breathing and breathing during exercise will differ from the typical single breath curve used to determine respiratory parameters. Oxygen consumption or carbon dioxide production is preferably estimated from the exhaled volume for a predetermined period of time, such as 1 minute, during rest or activity at a certain level of intensity.

VEQ may be described using a multi-parameter expression, including the effects of flow volumes, respiration frequency (breathing rate), and other physiological parameters such as heart rate. For example, an expression such as VEQ=A+BV_{E} can be used, where A and B are constants, and V_{E} is the exhaled volume per minute. V_{E} increases as exercise intensity level increases, however VEQ is nearly constant for low levels of activities.

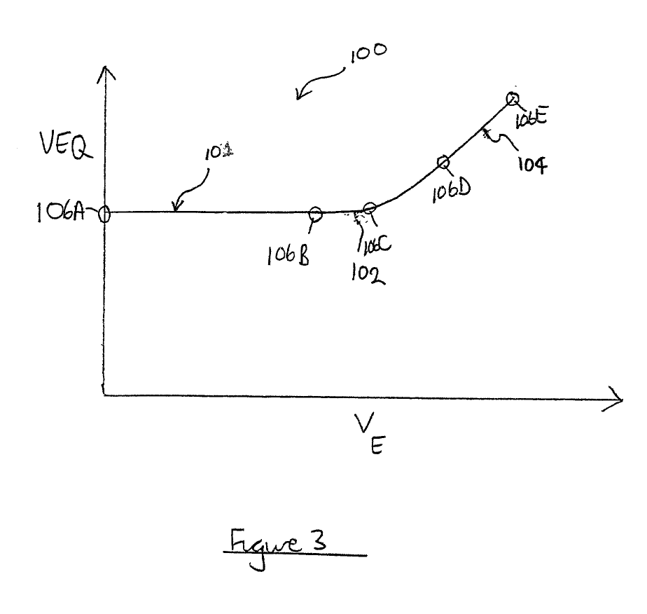

Referring to FIG. 3, a curve 100 relating V_{E} to VEQ is illustrated at 101. V_{E} is relatively constant up to the person's anaerobic threshold, as shown at 102, and then increases at a near-linear fashion, as shown at 104. Various measurement points are shown at 106A-106E, and are obtainable by the GEM during a calibration procedure. The VEQ curve can be interpolated between measurement points, or described by a mathematical equation fit to the measurement points. In this example, VEQ has a constant value (or a very weak dependence on V_{E}) for activity levels below the anaerobic threshold (AT) 102, and a value more strongly dependent on V_{E} for activity levels above AT. For example, V_{E} may be 30 for activity levels below AT, and a formula such as V_{E}=30+AX is used to describe activity levels above AT. Here, A is a constant for a given person, which may be determined in a calibration procedure using the GEM, and X is V_{E}, or alternatively X is (V_{E}−V_{EAT}), where V_{EAT} is the value of V_{E} at AT.

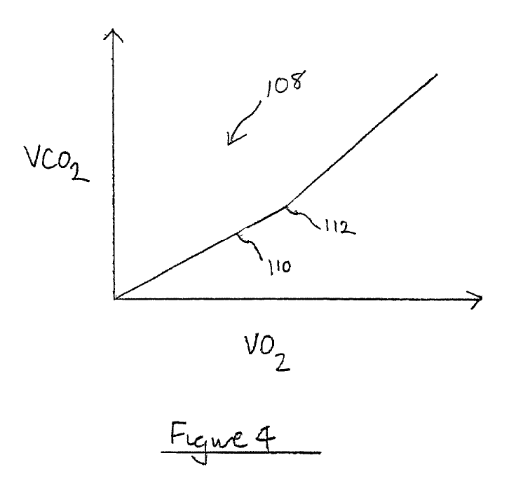

The GEM is adaptable to determine the anaerobic threshold (AT) of a person. For example, the GEM is used to determine VEQ and V_{E} for a person during an exercise of escalating intensity. Referring to FIG. 4, a curve 108 of VCO₂ with respect as to VO₂ is shown at 110, and the anaerobic threshold is determined from the change in the slope of the curve, as shown at 112. An example of this technique is further described in U.S. Pat. No. 6,174,289 to Binder, incorporated herein by reference.

It should be appreciated that a spirometer 1 for determining VEQ in a calibration process may not require a pressure sensor 34, since the exhaled pressure and inhaled pressure can be assumed to be the same for volume ratio determinations. Volumes of consumed oxygen would preferably be determined using a flow sensor 14 and an oxygen concentration sensor (not shown), and exhaled volumes determined using a flow sensor 14, and the volume ratio determined using appropriate temperature corrections.

In still another example, the ratio of exhaled volume to carbon dioxide production volume is determined to find VEQ(CO₂), and used to calibrate the spirometer 1. In still yet another example, a ratio of inhaled volume to carbon dioxide consumption or oxygen production volumes is formed and used in a calibration process, however in this case the temperature and humidity of inhaled gases is determined for correction of gas volumes to standard conditions.

In another embodiment, an indirect calorimeter is used for determining exhaled volume V_{E}, consumed oxygen V0₂, produced carbon dioxide VCO₂, and ventilatory equivalent VEQ for a person at rest and during exercises of different intensity levels. The indirect calorimeter includes a flow path 10, a flow sensor 14, an oxygen concentration sensor 50 and/or a carbon dioxide concentration sensor 52. A physiological monitor 54, such as a heart rate sensor, is used as an input to the processor 20 and to monitor the intensity level of an exercise. A physical activity sensor, such as a pedometer or GPS (global positioning system), is used to determine an exercise parameter, such as repetition rate or speed. VEQ correlates with a physiological function or exercise parameter. The anaerobic threshold is determined, and used in planning an exercise program. An example of this technique is described in U.S. Pat. No. 6,176,241 to Blau et al., which is incorporated herein by reference.

Another embodiment of a device for determining VEQ(CO₂) includes a flow sensor 14 and an instantaneous CO₂ concentration sensor 52. Since only exhaled air is being analyzed, the temperature need not be measured to determine VEQ(CO₂), and the effect of pressure can be neglected, therefore a pressure sensor is not required. If RQ is known, for example as measured for a given person, or assumed using demographic, diet data, and the like, then VEQ(O₂) can then be readily determined. For example, the device may include an ultrasonic flow transducer pair and an IR CO₂ sensor. V_{E} and VCO₂ are determined for a person's exhalations, and used to determine VEQ(CO₂) for the person. Humidity of the exhaled air is assumed to be 100%. RQ for the person is estimated, for example within the range RQ=0.80-0.85 for the person at rest after fasting, and used to determine a value for VEQ(O₂). A spirometer 1 having a flow sensor 14 and a pressure sensor 34 is then used to measure V_{E}, and hence determine resting metabolic rate for the person. In a simple model, pressure is assumed to be 1 atm, but this will be a source of computed error. The metabolic measurements are preferably made under conditions similar to those used in determining VEQ.

In a further embodiment, the spirometer 1 includes a flow path 10, a flow sensor 14 providing a signal correlating with flow rates along the flow path 10. The spirometer 1 also includes an instantaneous carbon dioxide sensor (capnometer) 52, such as an IR sensor, providing a signal correlated with carbon dioxide concentration within gases flowing through the flow path. Integration of flow data for exhalations gives V_{E}, and integration of flow data with CO₂ concentration data provides an exhaled CO₂ volume. For example, a person may exhale a V_{E} of 7.5 liters in one minute. Capnometer data, integrated with flow data, provides an exhaled CO₂ volume of 260 ml, at an assumed pressure of 1 atm and an assumed effective exhaled gas temperature of 32.5° C. At STP, this corresponds to a volume of 2.12 ml. Inhaled CO₂ can be corrected for, however this volume is negligible and can either be omitted or roughly estimated. For example, assuming an inhaled volume of 6.70 liters at STP (the exhaled volume at STP) and an atmospheric CO₂ concentration of 0.03%, the inhaled volume of CO₂ is approximately 2 ml. Hence, a reasonable estimate of inhaled CO₂ may be 1% of exhaled CO₂. From the produced volume of CO₂ of 258 ml, and assuming RQ=0.85, the RMR from the Weir equation is 2103 kcal/day, and minute VO₂ is 304 ml.

Hence an improved spirometer 1, adapted to provide an estimated metabolic rate, comprises a flow path 10; a flow sensor 14; a Capnometer 52; a processor 20 adapted to receive data from the capnometer 52 and flow sensor 14, to identify exhalations, to integrate exhaled flow data into exhaled flow volumes, and to integrate exhaled flow data and capnometer data into exhaled carbon dioxide volumes; a display 26 adapted to show measured metabolic rate; a memory 22, 24 to store data related to RQ, parameters associated with the Weir equation and any correction factors; a data entry mechanism 32 such as a switch whereby the user can enter a value for RQ; and a pressure sensor 34.

Yet a further embodiment of a low cost spirometer 1 includes a flow path and a flow sensor providing a signal correlating with flow rates along the flow path. The spirometer includes a mixing chamber and a gas component sensor disposed within the mixing chamber. The chamber is configured so as to provide mixing of gases passing through it, as is known in the art, for example using a turbulence inducing structure. The gas component (oxygen or carbon dioxide) sensor provides a signal that correlates the average concentration of the gas component within the respiration, preferably within an exhalation. This signal is averaged over a number of breaths, so as to provide an average gas component concentration for inhalations or exhalations. For example, a flow sensor may provide a signal indicative of an exhaled minute volume (V_{E}) of 7.5 liters. An oxygen sensor disposed within a mixing chamber provides a signal indicative of an average exhaled oxygen concentration of 16%, i.e. minute exhaled oxygen volume of 1.2 liters at the effective exhalation temperature, or 1.073 liters of oxygen at STP. The response time of the oxygen sensor need not be effectively instantaneous on the time scale of respiration, as it provides an average value, providing a cost savings. Using an assumed value of respiratory quotient (e.g. 0.85), the minute inhalation volume can be determined at STP. The inhaled oxygen concentration is the atmospheric oxygen concentration.

Hence, oxygen consumption is determined by subtracting the inhaled oxygen volume from the exhaled oxygen volume, and the metabolic rate of the person is calculated using the Weir equation. Advantageously, the flow path of the low cost spirometer includes one or more valves, so that only exhalations pass through the mixing chamber. In this case, the mixing chamber is used to store a number of breaths, so as to determine an average oxygen (or carbon dioxide) component concentration for a number of exhalations.

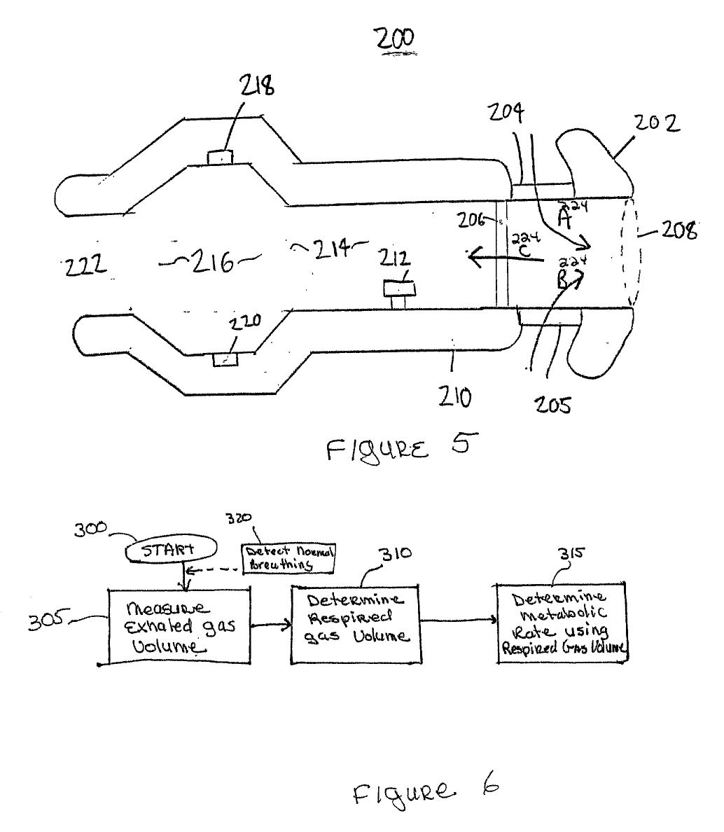

Referring to FIG. 5, an example of a spirometer 200 with one or more valves is illustrated. The spirometer 200 has a mouthpiece 202 with an aperture 208. Air is drawn in through valves 204 and 205, and exhalations pass through valve 206 into a flow path 214, the gas flow directions are indicated by arrows at 224A, 224B, 224C. The spirometer 200 includes a flow sensor 212 disposed within the flow path 214, a chamber 216, a radiation source 218 and radiation sensor 220 configured to measure the gas component concentrations within the chamber, and an outlet 222. The spirometer 200 also has an electronics circuit adapted to determine exhaled volumes using data from the flow sensor 212, and the average gas component concentration in the exhaled gases. A fluorescence gas sensor may also be used. An example of a flow sensor 212 is an ultrasonic transducer within the flow path 214. The metabolic rate of the user is determined from the exhaled volume and oxygen and/or CO₂ concentrations in the exhaled gas. It should be appreciated that the end-tidal oxygen and carbon dioxide concentrations for an individual tend to be constant, and these concentrations are used to calibrate data from respiratory analysis.

In still yet a further embodiment, the spirometer module is an accessory to a personal digital assistant (PDA) 60. An example is disclosed U.S. Pat. Nos. 6,159,147 and 5,827,179 to Lichter, the contents of which are incorporated herein by reference. The data entry mechanism 60A, display 60B, processor, and memory of the PDA are used to analyze data from the flow sensor in the spirometer module, and to calculate a metabolic rate. An algorithm on the PDA may be used to detect relaxed breathing for RMR detection. The module may be wirelessly connected to a PDA, so as to allow a module embedded in a mask to be worn during exercise.

Referring to FIG. 6, a method of determining a metabolic rate of a person using the cost-effective measuring devices previously described, is provided. The method begins in block 300 and advances to block 305. In block 305, the methodology measures an exhaled gas volume for the person using the spirometer 1, as previously described. The exhaled gas volume for the person is measured for a predetermined period of time, such as the volume of gas exhaled per minute).

Alternatively, breath volume is estimated by another technique. For example, a person is provided with a physiological monitor 54 such as a chest strap that transmits an electrical signal representative of chest expansion and contraction. The electrical signal is correlated with inhaled and exhaled volumes, and also correlated with metabolic measurements made using the GEM. Other physiological parameters may also be correlated with breath volume, and include a noise signal from the trachea, heart rate, pressure sensors near the mouth, noise signals from the chest, EKG signals, and other parameters. Advantageously, by relating exhaled volumes to metabolic rate, exhaled volume can be used in relaxation therapies.

The methodology advances to block 310 and determines a respired gas volume for the person using the exhaled gas volume and a ventilatory equivalent. The ventilatory equivalent (VEQ) for the person is preferably determined in a calibration procedure. The calibration procedure measures the oxygen consumed by the person (or carbon dioxide produced) as a function of exhaled gas volume. The calibration procedure is preferably carried out for the person at rest, so as to allow resting metabolic rate to be determined from exhaled volume measurements and VEQ. The calibration procedure can further be carried out for the person during exercise so as to allow ventilatory equivalent values to be determined over a range of exercise intensities. Exercise intensities, or activity levels, can be characterized by a physiological parameter sensitive to activity level such as heart rate, exhaled volume, and the like.

Alternatively, the VEQ is estimated from demographic information, such as age, gender, ethnicity, weight, height, and other physical characteristics. A database can be established for groups of people, for example participants in commercial weight control programs, and the database can subsequently be used to estimate VEQ for a person. VEQ can be determined for a person by comparing demographic data for the person with that of other persons for whom VEQ has been measured, i.e. using a database maintained on a central health network 38. A person may provide demographic data to a software program running on a computing device, the program estimating VEQ from the data.

It should be appreciated that oxygen consumption for a person sitting or standing may be slightly higher than for the person in a fully relaxed position, such as lying down. However, VEQ is similar in both cases, and also for mild exercise levels below the anaerobic threshold. Hence, VEQ can be determined for a person in a semi-relaxed state using e.g. a suitably adapted indirect calorimeter, and the value of VEQ used for RMR measurements even if VEQ is not determined in a fully relaxed state.

A calibration curve of VEQ versus total exhaled volume V_{E} is established for a person, e.g. using a suitably adapted GEM The value of VEQ may rise as V_{E} increases due to exercise. The personal calibration curve can be transmitted in some convenient manner to a spirometer 1. It should be appreciated that VEQ can also be correlated with other parameters, such as respiration frequency, heart rate, skin temperature, and other physiological parameters in a manner to be described.

The methodology advance to block 315 and determines the metabolic rate for the person from the respired gas volume. The respired gas volume is preferably the volume of oxygen consumed by the person, but may also be the volume of carbon dioxide produced by the person. Gas volumes are conventionally measured in milliliters per minute (ml/min), but other volume and time periods can be used with according modification of any metabolic equations using the measurements.

It should be appreciated that calculation of metabolic rate improves if the respiratory quotient is known. The respiratory quotient RQ is the ratio of CO₂ volume produced to oxygen volume consumed. For metabolism of carbohydrates only, the value is unity. If proteins and fat are also being metabolized, RQ is less than unity.

For a person on a regulated diet, or a person having an accurate diet log, the value of RQ can be estimated based on diet components expected to be metabolized at the time of measurement. For example, REE is determined at a predetermined time, such as 3 hours after a balanced meal is consumed. Measurements for representatives of various demographic groups can be used to estimate RQ under such conditions. A GEM or other such respiratory analyzer with oxygen and/or carbon dioxide sensors can also be used to determine RQ for the person after various meals. A database is established by the RQ, so that the RQ is estimated for a person using demographic information, physiologic information (such as RMR and body fat percentage), diet log data, and time from previous meals eaten.

A spirometer 1 equipped with pressure, temperature and humidity sensors 34, 40, 42 provides for correction of inhaled volumes to standard volumes. If VEQ is known, the difference between inhaled and exhaled volumes is related to respiratory quotient RQ. RQ is calculated, giving information on metabolic processes; however, accurate volume measurements are needed.

Calorie density, the calorie deficit required for one pound of body weight loss, is conventionally assumed to be 3,500 calories per pound. However, this is determinable more accurately from the person's diet log, allowing a more accurate estimate of weight loss from a given calorie deficit to be made.

A person's breathing may be unnatural after starting to use a spirometer 1. The methodology may also include the step of detecting the onset of normal breathing before measuring the gas volumes as shown at 320. Data from the first few breaths can be discarded.

Alternatively, the metabolic rate for the person is determined using the exhaled gas volume and a numerical parameter. The numerical parameter is related to the ventilatory equivalent of the person. The ventilatory equivalent for oxygen for a person is typically in the range 20-40 for normal subjects who are not hyperventilating or sick. Hence, a spirometer 1 may be provided which determines the exhaled volume of gas for the person and determines the metabolic rate of the person using an assumed ventilatory equivalent in the range 20 to 40.

For example, a person measures their exhaled volume (V_{E}, minute ventilation) as 7.5 liters using a spirometer 1. Assuming an exhaled humidity of 100%, and effective temperature of exhaled gases within the spirometer 1 of 32.5° C., this corresponds to a dry volume of 7.14 liters, and a volume of 6.38 liters at STPD. Assuming a ventilatory equivalent for oxygen of 28, this corresponds to an oxygen consumption volume of 228 ml. Assuming a respiratory quotient of 0.85, this corresponds to an RMR of 1580 kcal/day, using the Weir equation.

Alternatively, V_{E} and RMR may be experimentally correlated using an indirect calorimeter. Suppose a person has an RMR of 1580 kcal/day while exhaling a minute volume of 7,500 milliliters, as determined using a spirometer 1. In this case, an equation of the form RMR=BV_{E} can be used, where B (a constant of proportionality between exhaled (minute) volume and resting metabolic rate) has the value 0.21 kcal/day⁻¹ml⁻¹. The effective term B includes a contribution from VEQ, and may be calculated using a measured or assumed value of VEQ. Measurement of V_{E} then allows determination of RMR without the use of an indirect calorimeter. It should be appreciated that metabolic rate during exercise can be determined using a similar method.

The effective temperature of exhaled gases within the flow path of the spirometer 1 may be flow rate dependent, but this can readily be corrected for. A person may initially hyperventilate when breathing into a spirometer 1, but this can be detected using an algorithm. Metabolic rates may be determined when tidal volumes have leveled off to a normal level, when respiratory frequency has leveled off, or when some other respiratory or physiological parameter has normalized after an initial period.

It should be appreciated that having measured RMR using an indirect calorimeter, further measurements can be determined. For example, a person's body fat percentage can be calculated by comparing the measured RMR reading with the parameters used in the Harris-Benedict equation. For a given set of demographic data, such as age, ethnicity, gender, height, and weight, RMR increases as body fat decreases. Body fat does not contribute to RMR. In another example, the GEM may be used in which the user enters demographic data, and receives a calculation of body fat determined by the measured RMR.

In another example, a person's total energy expenditure TEE can be calculated. TEE is the sum of resting energy expenditure REE and activity energy expenditure AEE, i.e. TEE=REE+AEE. REE is significantly larger than AEE, and can be determined accurately using an indirect calorimeter such as the GEM. However, knowing REE, TEE can be estimated with reasonable accuracy using a spirometer 1 and knowledge of VEQ. A person may carry a spirometer 1, equipped with a respiratory connector (not shown) such as a helmet, mouthpiece or mask. Measurement of V_{E} allows TEE to be estimated during exercise. Subtracting the value of REE determined using the GEM gives an estimate of AEE, which can be used in calorie balance applications. Hence, a method of measuring AEE for an activity includes the steps of measuring REE using the GEM, measuring a ventilatory equivalent (VEQ), at rest and at one or more activity levels; measuring V_{E} during an activity using a spirometer 1; determining TEE for the activity from V_{E} and VEQ; and estimating the activity energy level by subtracting REE from TEE. The estimated AEE can then be used in a calorie management program, such as that disclosed in U.S. patent application Ser. No. 09/685,625 also to Mault, the disclosure of which is incorporated by reference.

It should also be appreciated that metabolic rate can be estimated from a combination of one or more physiological parameters. For example, in U.S. Pat. No. 6,030,342 to Amano, incorporated herein by reference, a combination of heart rate and body temperature measurements are used to estimate a person's metabolic rate. Physiological parameters are correlated with metabolic rate using an indirect calorimeter. For example, heart rate, total exhaled volume (V_{E}), body temperature, respiration frequency, skin temperature and other physiological parameters may be correlated. During exercise, a person measures heart rate, and correlates the heart rate with the metabolic rate determined using the GEM. In future exercises, the person carries a heart rate monitor only and estimates their metabolic rate from the heart rate measured by the sensor, by subtracting their known resting metabolic rate from the value suggested by the heart rate, and activity energy expenditure is determined for the exercise. It should be appreciated that activity energy expenditure may be used in the calorie management programs previously described.

The ventilatory equivalent VEQ and one or more physiological parameters are combined to estimate a person's metabolic rate. Alternatively, VEQ is correlated with a physiological parameter, for example using an equation such as VEQ=A+Bf, where A and B are constants and f is a pulse rate, to estimate the person's metabolic rate.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A method of metabolic rate measurement for an individual, the method comprising the steps of:
measuring an exhaled gas volume for the individual using a spirometer having a flow path enclosed by a flow tube, and a flow sensor disposed in the flow path for sensing the exhaled gas flow from the individual, a display and a processor having a memory that processes a signal from the flow sensor;
determining a respired gas volume for the individual using the exhaled gas volume and a ventilatory equivalent; and
determining a metabolic rate for the individual from the respired volume.

2. The method of claim 1, including the step of using the ventilatory equivalent for oxygen, wherein the ventilatory equivalent is determined from a predetermined calibration relationship between oxygen consumed by the individual as a function of exhaled gas volume.

3. The method of claim 1, including the step of using the ventilatory equivalent for oxygen, wherein the ventilatory equivalent for oxygen is determined from predetermined demographic data related to the individual stored in the memory of the processor.

4. The method of claim 1, including the step of determining a ventilatory equivalent while the individual is at rest and using the resting ventilatory equivalent and the exhaled volume to determine a resting metabolic rate.

5. The method of claim 4, including the step of determining a ventilatory equivalent while the individual is exercising and using the exercise ventilatory equivalent and the exhaled volume to determine an exercise metabolic rate.

6. The method of claim 5 including the step of determining an activity energy expenditure for the individual during exercise by determining an exercise metabolic rate for the individual during the exercise using the exercise ventilatory equivalent and determining the activity energy expenditure for the exercise by subtracting the resting metabolic rate of the person from the exercise metabolic rate.

7. The method of claim 6, including the step of determining a total energy expenditure as a sum of the resting energy expenditure and the activity energy expenditure for the individual.

8. The method of claim 7 wherein the resting energy expenditure is determined using a gas exchange monitor.

9. The method of claim 1, including the step of determining a ventilatory equivalent while the individual is exercising and using the exercise ventilatory equivalent and the exhaled volume to determine an exercise metabolic rate.

10. The method of claim 1, including the step of determining the ventilatory equivalent for carbon dioxide and using the ventilatory equivalent for carbon dioxide in determining the metabolic rate.

11. The method of claim 1, wherein said step of using the ventilatory equivalent includes the step of determining the ventilatory equivalent from a physiological parameter of the individual.

12. The method of claim 1, including the step of determining if the individual's breathing is normal before measuring the exhaled gas volume.

13. The method of claim 1, wherein the ventilatory equivalent is determined for the person using an indirect calorimeter adapted to be worn by the person during performance of an exercise.

14. The method of claim 1 including the step of initially determining a ventilatory equivalent using an indirect calorimeter.

15. A method of determining the resting metabolic rate of a person using a flow meter, the method comprising:
measuring an exhaled volume for the person using the flow meter;
determining a consumed volume of oxygen from the exhaled volume using a ventilatory equivalent for oxygen, the ventilatory equivalent for oxygen being determined in an initial procedure; and
determining the resting metabolic rate from the consumed value of oxygen.

16. The method of claim 15, wherein the initial procedure includes the step of measuring the ventilatory equivalent for oxygen by determining exhaled flow volumes and consumed oxygen volumes.

17. A method of determining a metabolic rate of a person, the method comprising the steps of
determining an exhaled volume;
determining a component gas average concentration in the exhaled volume, wherein the component gas is either oxygen or carbon dioxide;
determining a component gas exhaled volume from the component gas average concentration and the exhaled volume;
estimating an inhaled volume for the person;
determining a component gas inhaled volume from the inhaled volume and a component gas inhaled concentration;
determining a difference volume between the component gas inhaled volume and the component gas exhaled volume; and
determining the metabolic rate of the person using the difference volume.

18. A spirometer for determining a metabolic rate for an individual comprising:
a flowpath;
a flow sensor disposed in said flow path, wherein said flow sensor senses a flow rate of exhaled gas from the individual through said flow path;
a processor having a memory in communication with said flow sensor, wherein said processor receives a signal from said flow sensor of flow rate, integrates the flow rate data, and determines a metabolic rate from a ventilatory equivalent and the flow rate measurement.

19. The spirometer of claim 18 further comprising a data entry mechanism.

20. The spirometer of claim 18 further comprising a display for displaying the determined metabolic rate.

21. The spirometer of claim 18, further comprising a pressure sensor, wherein a measured pressure is used to correct the flow volume of exhaled gas to a standard pressure.

22. The spirometer of claim 15, wherein said flow sensor is an ultrasonic transducer for measuring temperature, humidity and pressure.

23. The spirometer of claim 18, wherein said spirometer is operatively in communication with a personal digital assistant.

24. The spirometer of claim 18, further comprising a capnometer for measuring a flow volume of CO₂, and the ratio of exhaled volume to carbon dioxide production volume is used to determine the ventalatory equivalent for carbon dioxide.

25. The spirometer of claim 18 further comprising a temperature sensor 40 for measuring the temperature of the exhaled gas.

26. The spirometer of claim 18 further comprising a wireless network connection for communication with a central health network over a communications network.

27. A spirometer for determining a metabolic rate for an individual comprising:
a flow path;
a flow sensor disposed in said flow path, wherein said flow sensor senses a flow rate of exhaled gas from the individual through said flow path;
a mixing chamber integral with said flow path and a gas component sensor disposed in said mixing chamber for sensing a composition of the exhaled gas, wherein the gases passing through the mixing chamber are mixed together;
a processor having a memory in communication with said gas component sensor and said flow rate sensor; wherein said processor receives a signal from said flow sensor of flow rate and a signal from said gas component sensor that correlates the average concentration of the gas component within the respiration, integrates the flow rate data, determines oxygen consumption by subtracting the inhaled oxygen volume from the exhaled oxygen volume and determines a metabolic rate from the oxygen consumption.

28. A spirometer as set forth in claim 27 wherein said mixing chamber stores a plurality of breaths for determining an average oxygen component concentration for a plurality of exhalations.

29. A spirometer as set forth in claim 27 further comprising a mouthpiece with an aperature transmitting air into the flow path.

30. A spirometer as set forth in claim 27 further comprising an inhalation valve and an exhalation valve disposed between said mouthpiece and said flow path, wherein inhaled air passes through said inhalation valve and exhaled air passes through said exhalation valve.
